(19) United States
(12) Patent Application Publication
(10) Pub. No.: US 2011/0208921 A1
(43) Pub. Date: Aug. 25, 2011

(54) INVERTED DEFAULT SEMANTICS FOR IN-SPECULATIVE-REGION MEMORY ACCESSES

(76) Inventors: Martin T. Pohlack, Dresden (DE); Michael P. Hohmuth, Dresden (DE); Stephan Diestelhorst, Dresden (DE); David S. Christie, Austin, TX (US); Jaewoong Chung, Bellevue, WA (US)

(21) Appl. No.: 12/708,919

(22) Filed: Feb. 19, 2010

(51) Int. Cl. G06F 12/00; G06F 12/14

(52) U.S. Cl. 711/147; 711/152; 711/E12.001; 711/E12.098

(57) ABSTRACT

A method for accessing memory by a first processor of a plurality of processors in a multi-processor system includes, responsive to a memory access instruction within a speculative region of a program, accessing contents of a memory location using a transactional memory access to the memory access instruction unless the memory access instruction indicates a non-transactional memory access. The method may include accessing contents of the memory location using a non-transactional memory access by the first processor according to the memory access instruction responsive to the instruction not being in the speculative region of the program. The method may include updating contents of the memory location responsive to the speculative region of the program executing successfully and the memory access instruction not being annotated to be a non-transactional memory access.

### BACKGROUND

1. Field of the Invention

This application is related to computing systems and more particularly to parallel processing computing systems.

2. Description of the Related Art

In an exemplary multi-core processor system, shared memory facilitates communication between processors via reads and writes of shared data. Coordinating memory accesses of multiple application threads accessing a shared memory in parallel increases programming complexity, which discourages programmers from fully utilizing parallel programming techniques. Techniques for managing memory accesses in a parallel programming environment include locking techniques, transactional memory, and other techniques (e.g., lock-free programming).

### SUMMARY OF EMBODIMENTS OF THE INVENTION

In at least one embodiment of the invention, a method for accessing memory by a first processor of a plurality of processors in a multi-processor system includes, responsive to a memory access instruction in a speculative region of a program, accessing contents of a memory location using a transactional memory access according to the memory access instruction unless the memory access instruction indicates a non-transactional memory access. The method may include accessing contents of the memory location using a non-transactional memory access by the first processor according to the memory access instruction responsive to the instruction not being in the speculative region of the program. The method may include updating contents of the memory location responsive to the speculative region of the program executing successfully and the memory access instruction not being annotated to be a non-transactional memory access.

In at least one embodiment of the invention, an apparatus includes a plurality of processor cores responsive to access a memory and at least a first processor core of the plurality of processor cores responsive to access the memory. The first processor core is responsive to execute a non-transactional memory access instruction as a transactional memory access when the non-transactional memory access instruction is located within a speculative region of code. The first processor core may include an instruction decoder responsive to generate an indicator of a transactional memory access in response to a memory access instruction without an indicator of transactional memory access responsive to the memory access instruction being within a speculative region of an instruction sequence.

In at least one embodiment of the invention, an apparatus includes an instruction decoder responsive to generate an indicator of a transactional memory access in response to a memory access instruction without an indicator of transactional memory access, when the memory access instruction is located in a speculative region of an instruction sequence.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of an exemplary multi-core processor portion including a synchronization facility.

FIG. 2 illustrates a functional block diagram of an exemplary processor core including a synchronization facility consistent with at least one embodiment of the invention.

FIG. 3 illustrates exemplary information and control flows for an exemplary synchronization facility.

FIG. 4 illustrates information and control flows for a synchronization facility with inverted default semantics for in-speculative region memory accesses consistent with at least one embodiment of the invention.

FIGS. 5A and 5B illustrate exemplary routines for execution on the processor core of FIG. 2 using inverted default semantics for in-speculative-region memory accesses.

The use of the same reference symbols in different drawings indicates similar or identical items.

### DETAILED DESCRIPTION

In general, transactional memory allows a group of load and store instructions to execute atomically and in isolation. As referred to herein, a transaction is a single operation on data. A transaction executes atomically if either all of the instructions in the transaction are executed, or none of the instructions in the transaction are executed. The isolation property requires that other operations cannot access data in an intermediate state during a transaction. Accordingly, each transaction is unaware of other transactions executing concurrently in a system. An instruction is referred to as being executed in isolation if no results of the instruction are exposed to the rest of the system until the transaction completes. Multiple transactions may execute in parallel if those transactions do not conflict. For example, two transactions conflict if those transactions access the same memory address and either of the two transactions writes to that address.

Software transactional memory provides transactional memory semantics in a software runtime library or a programming language, and generally does not include hardware support. For example, software transactional memory may provide an atomic compare and swap operation, or equivalent. Hardware transactional memory is an architectural technique for supporting parallel programming, which may include modifications to processors, cache and bus protocols to support transactions. Exemplary techniques for implementing transactional memory are included in U.S. Provisional Application No. 61/084,008, filed Jul. 28, 2008, entitled “Advanced Synchronization Facility,” naming Michael Hohmuth, David Christie, and Stephan Diestelhorst as inventors; U.S. patent application Ser. No. 12/510,856, filed Jul. 28, 2009, entitled “Processor with Support for Nested Speculative Sections with Different Transactional Modes,” naming Michael P. Hohmuth, David S. Christie, and Stephan Diestelhorst as inventors; U.S. patent application Ser. No. 12/510,884, filed Jul. 28, 2009, entitled “Hardware Transactional Memory Support for Protected and Unprotected Shared-Memory Accesses in a Speculative Section,” naming Michael Hohmuth, David Christie, and Stephan Diestelhorst as inventors; U.S. patent application Ser. No. 12/510,893, filed Jul. 28, 2009, entitled “Coexistence of Advanced Hardware Synchronization and Global Locks,” naming Michael Hohmuth, David Christie, and Stephan Diestelhorst as inventors; U.S. patent application Ser. No. 12/510,905, filed Jul. 28, 2009, entitled “Virtualizable Advanced Synchronization Facility,” naming Michael Hohmuth, David Christie, and Stephan Diestelhorst as inventors; and U.S. Provisional Application No. 61/233,808, filed Aug. 13, 2009, entitled “Combined Use of Load Store Queue and Cache for Transactional Data Buffering,” naming Jaewoong Chung, David Christie, Michael Hohmuth, Stephan Diestelhorst, and Martin Pohlack as inventors, which applications are incorporated by reference herein in their entirety. An exemplary hardware transactional memory includes a set of hardware primitives that provide the ability to atomically read and modify a memory location. A programmer may use those primitives to build a synchronization library (e.g., atomic exchange).

In at least one embodiment, a processing element or central processing unit core (hereinafter referred to as a “processor core” or “core”) including a transactional memory facility, i.e., synchronization facility, (e.g., Advanced Micro Devices, Inc. Advanced Synchronization Facility Revision 2.1 AMD64 extension) executes instructions atomically and in isolation in response to a declaration enclosing a group of instructions as a transaction. In at least one embodiment, the core including a synchronization facility begins a transaction by taking a register checkpoint, e.g., saves copies of contents of particular state registers (e.g., stack pointer, rSP, and instruction pointer, rIP) in a shadow register file or other suitable storage device. Whenever the core writes to memory, transactional data produced by the write operation are maintained separately from old data by either buffering the transactional data or by logging the old value (e.g., data versioning). The core including a synchronization facility records the memory addresses read by the transaction in a read-set and those written in a write-set. The synchronization facility detects a conflict against another transaction by comparing the read-sets and the write-sets of both transactions. If a conflict is detected, the transaction is rolled back by undoing transactional write operations, restoring a state of the machine from the register checkpoint, and discarding any transactional metadata. Absent a conflict, the transaction ends by committing transactional data and discarding any transactional metadata and the register checkpoint.

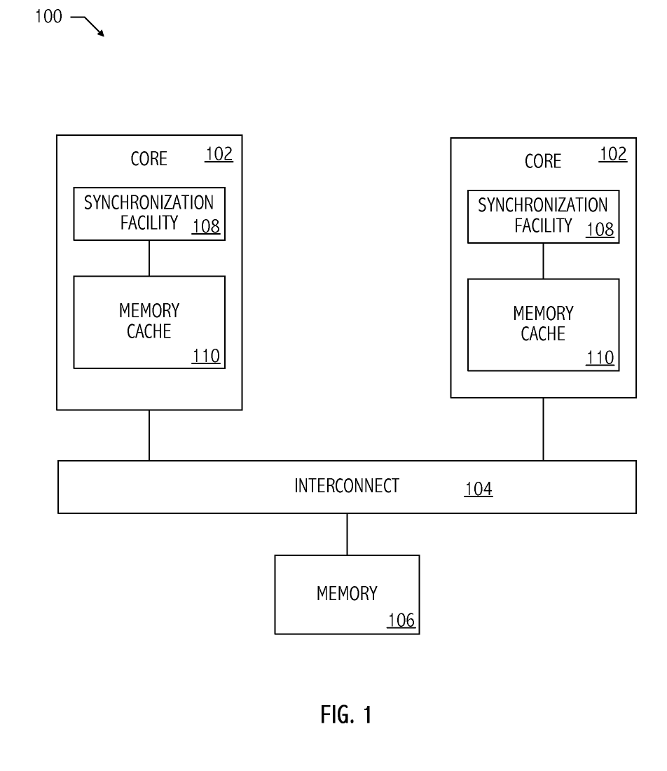

Referring to FIG. 1, an exemplary processor system (e.g., computing system 100) includes multiple processor cores (e.g., processor cores 102), which are coupled to each other and a shared memory (e.g., memory 106) via an interconnect network (e.g., interconnect 104), which may be a crossbar or other suitable bus structure. Each processor core 102 includes a memory cache (e.g., cache 110), which may be a multi-level cache, and a synchronization facility (e.g., synchronization facility 108).

In at least one embodiment of computing system 100, cores 102 implement a 64-bit AMD64 architecture, although the invention is not limited thereto. Cores 102 include instruction set extensions to support a synchronization facility consistent with the description above. In at least one embodiment, cores 102 implement at least the five exemplary instructions of Table 1 to support the synchronization facility.

TABLE 1
Instruction Set Extension

| Category | Instruction | Function |
|---|---|---|
| Transaction | SPECULATE | Start a transaction |
| Boundary | | |
| Transaction | COMMIT | End a transaction |
| Boundary | | |
| Transactional | LOCK MOV [Reg], | Load from [Addr] to [Reg] |
| Memory Access | [Addr] | transactionally |
| Transactional | LOCK MOV [Addr], | Store from [Reg] to [Addr] |
| Memory Access | [Reg] | transactionally |
| Context Control | ABORT | Abort a current transaction |

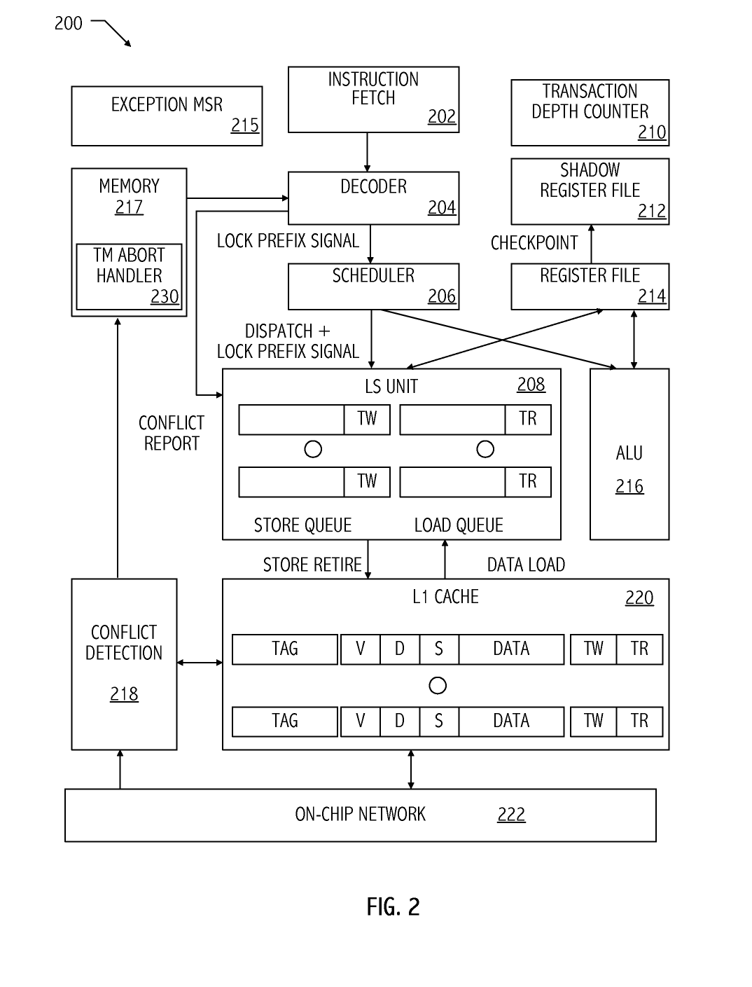

A SPECULATE instruction begins a transaction. Referring to FIGS. 1 and 2, in response to a SPECULATE instruction, core 102 sets flags and writes a status code that distinguishes between entry into a speculative region and an abort situation. In response to the SPECULATE instruction, core 102 implements a register checkpoint that includes copying the program counter and the stack pointer into corresponding registers in shadow register file 212. Additional suitable state information may also be saved in registers in shadow register file 212. A SPECULATE instruction is followed by one or more instructions that may jump to an error handler according to the status code.

A declarator instruction (e.g., LOCK MOV, LOCK PREFETCH, and LOCK PREFETCHW) specifies a location for transactional memory access. For example, in response to a LOCK MOV instruction, core 102 moves data between registers and memory 106, similar to a typical x86 MOV instruction (or other suitable load/store instruction). Once a memory location has been protected using a declarator instruction, the memory location may be read by a regular instruction. However, to modify protected memory locations, a memory-store form of LOCK MOV is used and core 102 generates an exception if a regular memory updating instruction is used. A LOCK MOV instruction may only be used within transaction boundaries, i.e., within a speculative region. Otherwise core 102 triggers an exception. In addition, core 102 processes the LOCK MOV instruction transactionally (i.e., using data versioning and conflict detection for the access). Core 102 detects a conflict when the same address is accessed later from another core 102, either by a transactional access or a non-transactional access, and at least one of the LOCK MOV and the later accessing instruction writes to the address. In at least one embodiment, computing system 100 implements write-back memory accesses to reduce complexity, although techniques described herein may be applied to computing systems implementing other memory access techniques.

In at least one embodiment, core 102 supports a RELEASE instruction. If implementation-specific conditions allow it, core 102 clears any indicators of a transactional load access to an address by LOCK MOV in response to the RELEASE instruction for a protected or speculatively written memory access. Core 102 stops detecting conflicts to the address as if the load access never occurred. However, the RELEASE instruction is not guaranteed to release unmodified protected addresses. If the RELEASE instruction is used for an address that was previously modified by LOCK MOV, core 102 does not release the protected address. Core 102 ignores a RELEASE instruction (e.g., performs a NOP) if the RELEASE instruction is called for an unprotected or non-transactional memory access. In at least one embodiment, core 102 does not support a RELEASE instruction. In response to a RELEASE instruction, embodiments of core 102 that do not support the RELEASE instruction do nothing (e.g., perform a NOP) in response to the RELEASE instruction.

In response to a COMMIT instruction, core 102 completes a transaction. An associated register checkpoint is discarded and the transactional data are committed to memory and exposed to other cores (e.g., another core 102).

In response to an ABORT instruction, core 102 rolls back a transaction. Core 102 discards transactional data and the register checkpoint is restored from shadow register file 212 into register file 214. Execution flow continues with an outermost SPECULATE instruction of nested SPECULATE instructions and terminates a transactional operation. In at least one embodiment of core 102, in addition to the ABORT instruction and a transaction conflict, core 102 aborts a transaction in response to other conditions and core 102 uses a register and/or flags (e.g., accumulator register, rAX, and a register indicating processor state, rFLAGS) to pass an abort status code to software, which may respond to the transaction abort according to the status code. In at least one embodiment, core 102 executes code in a speculative region if the speculative region does not exceed a declarator capacity, no interrupt or exception is delivered to core 102 while executing the speculative region, and there are no conflicting memory accesses from other cores 102. In at least one embodiment, core 102 aborts speculative regions of code due to contention, far control transfers (i.e., control-flow diversions to another privilege level or another code segment, e.g., interrupts and faults), or software aborts. The transaction abort status code register may be a general purpose register or a dedicated register. Embodiments of core 102 that use a dedicated register require operating system support for context switches. In at least one embodiment, core 102 includes pipelined execution units (e.g., instruction fetch unit 202, instruction decoder 204, scheduler 206 and load/store unit 208) and synchronization facilities (e.g., a flag indicating whether a transaction is active, which may be included in register file 214 or other suitable storage element, transaction depth counter 210, shadow register file 212, transactional memory abort handler 230, conflict detection unit 218, and exception machine state register 215, which may be included in register file 214). In at least one embodiment of core 102, one or more of the pipeline execution units (e.g., instruction decoder 204) are adapted to implement the instruction set extensions described above. In at least one embodiment of core 102, synchronization facilities are included in memory structures. For example, level-one cache 220 includes a transactional read (TR) bit and a transactional write (TW) bit per cache line for transactional loads and stores, respectively. Load/store unit 208 includes a TW bit per store queue entry and a TR bit per load queue entry. Core 102 uses shadow register file 212 to checkpoint at least an instruction pointer and a stack pointer. Decoder 204 recognizes and decodes the instruction set extensions. Transaction depth counter 210 counts a nesting level for nested transactions.

In response to a SPECULATE instruction, core 102 begins a transaction by taking a register checkpoint of an instruction pointer and stack pointer (e.g., rIP and rSP) by shadow register file 212 and by increasing transaction depth counter 210. In at least one embodiment of core portion 200, a register checkpoint is not taken in response to a nested SPECULATE since aborted transactions restart from the outermost SPECULATE for flat nesting.

In at least one embodiment, core 102 includes a locked line buffer. When writing a value in response to a transactional memory modification (e.g., a LOCK MOV instruction), core 102 writes an entry in the locked line buffer to indicate a cache block and the value it held before the modification. In the event of a rollback of the transaction, core 102 uses entries in the locked line buffer to restore a pre-transaction value of each cache line to local cache.

In at least one embodiment of core 102, in response to a LOCK MOV instruction, instruction decoder 204 sends a signal to the load/store unit 208 indicating a transactional read or transactional write when the instruction is dispatched. In response to the signal, load/store unit 208 sets a TW bit in a store queue entry for a store operation and a TR bit in a load queue entry for a load operation. Load/store unit 208 clears the TR bit in the load queue entry when the LOCK MOV retires, and the corresponding TR bit in the cache is set by then. Load/store unit 208 clears the TW bit in the store queue entry when the transactional data are transferred from the store queue to the cache. Level-1 cache 210 sets the TW bit in the cache. If core 102 writes transactional data to a cache line that contains non-transactional dirty data (i.e., the cache line has a dirty state), core 102 writes back the cache line to preserve the last committed data in the L2/L3 caches or main memory. In embodiments of core 102 that support a RELEASE instruction, in response to the RELEASE instruction, level-1 cache 210 clears the dirty state of the cache line that corresponds to the release address. Level-1 cache 210 triggers an exception if the TW bit of the corresponding cache line is set or there is a matching entry in the store queue of load/store unit 208.

In at least one embodiment, core 102 detects a transaction conflict by comparing incoming cache coherence messages against the TR and TW bits in the cache and the portion of the store queue that contains store operations of retired instructions. A transaction conflict may occur when core 102 detects a message for data invalidation and a corresponding TW bit or TR bit is set. A transaction conflict may also occur when the message is for data sharing and the TW bit is set. In at least one embodiment, core 102 uses an attacker-win contention management scheme for conflict resolution, i.e., a core receiving the conflicting message triggers a transaction abort and nothing about the conflict is reported to a core that has sent the message. Software techniques may be used to mitigate any live-lock issues from this approach. In at least one embodiment, when a conflict is detected, core 102 invokes an abort handler (e.g., transactional memory abort handler 230 stored in memory 217) that invalidates the cache lines with the TW bits, clears all TW/TR bits, restores the register checkpoint, and flushes the pipeline. Instruction execution flow starts from the instruction right after an outermost SPECULATE. In at least one embodiment of core 102, the abort handler is also triggered by ABORT, the prohibited instructions, transaction overflow, interrupts, and exceptions. If the transaction reaches COMMIT, core 102 commits the transaction by clearing all TW/TR bits, discarding the register checkpoint, and decreasing the transaction depth counter.

In at least one embodiment, core 102 aborts a transaction when core 102 detects a transaction overflow of the cache. For example, core 102 detects a transaction overflow when a transfer of the TW/TR bits from load/store unit 208 to L1 cache 210 results in a cache miss (i.e., no cache line is available to retain the bits) and all cache lines of the indexed cache set have their TW and/or TR bits set (i.e., no cache line is available for eviction to evict without triggering an overflow). In at least one embodiment of core 102, a logic circuit is configured to determine whether all cache lines of an indexed cache set have their TW and/or TR bits set. In at least one embodiment of core 102, if a non-transactional access meets those two conditions, L1 cache 210 handles a transaction as if it were an uncacheable type to avoid a transaction overflow. To hold as much transactional data as possible, in at least one embodiment of core 102, the cache eviction policy of core 102 gives a higher priority to cache lines with the TW/TR bits set.

To further avoid transaction overflows, in at least one embodiment, core 102 maintains the TW/TR bits in the load/store queues when the two conditions described above are satisfied. A transaction overflow is triggered when the load/store queues do not have an available entry for an incoming memory access (i.e., the TW/TR bits of all entries are set in the queue to which the access goes). Core 102 needs at least one queue entry for non-transactional accesses to make forward progress when the TW/TR bits of the other entries are set.

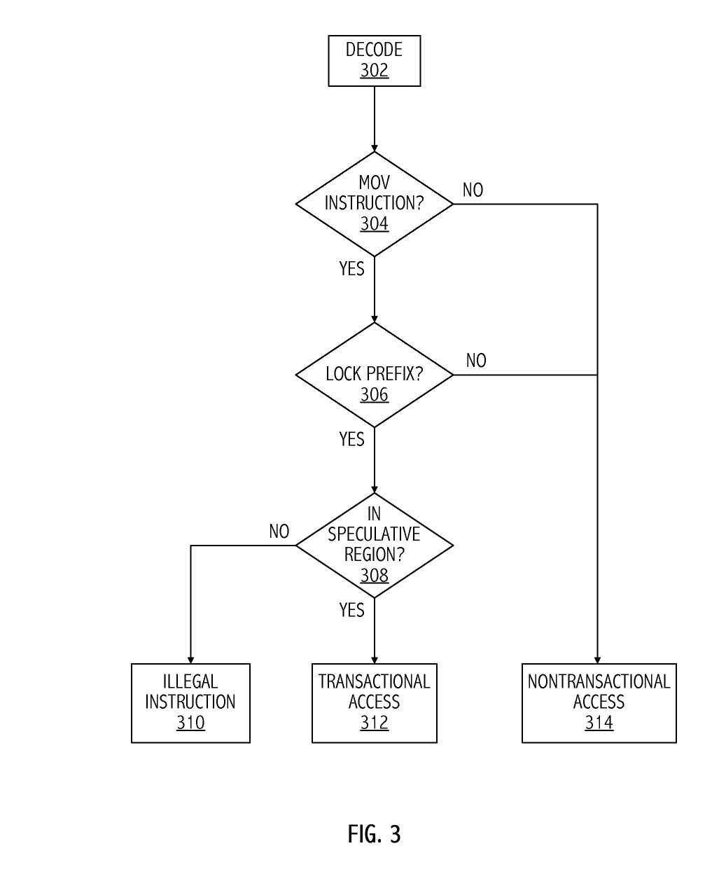

Referring to FIG. 3, in at least one embodiment, core 102 decodes and executes transactional memory accesses according to control flow 300. Core 102 handles memory accesses that are within a speculative region of code (e.g., delineated by transaction boundary instructions) and annotated using declaratory instructions (e.g., using a prefix) as transactional memory accesses and all other accesses as non-transactional. Core 102 decodes an instruction (302). If the instruction is not a move-type instruction (e.g., load/store instruction) (304), then core 102 executes the instruction as a non-transactional access (314). If the instruction is a move-type instruction (304), but does not include a prefix (e.g., LOCK prefix) or other annotation indicative of a transactional access (306), then core 102 executes the instruction as a non-transactional access (314). If the instruction is a move-type instruction (304), and includes a prefix or other annotation indicative of a transactional access (306) and the instruction is in a speculative region of code (i.e., a region of code delineated by instructions indicative of transactional access, e.g., between SPECULATE and COMMIT instructions), then core 102 executes the instruction as a transactional access (312). If the instruction is a move-type instruction (304), and includes a prefix or other annotation indicative of a transactional access (306) and the instruction is not in a speculative region of code, then the instruction is an illegal instruction (312), which may result in an exception.

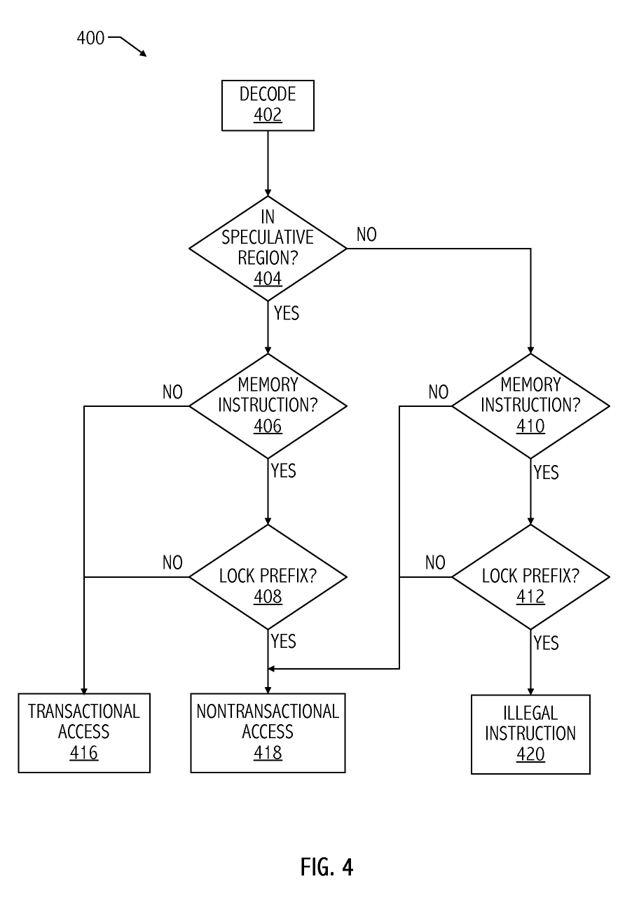

Referring to FIG. 4, in at least one embodiment, core 102 implements inverted default semantics for in-speculative region memory accesses. For example, core 102 decodes and executes transactional memory accesses according to control flow 400. Core 102 handles all memory accesses within a speculative region as transactional, as a default, and those memory accesses serve as declaratory instructions for future memory access instructions in the speculative region. A non-transactional access within the speculative region is annotated to indicate a non-transactional memory access. In at least one embodiment, within a speculative region of code, a LOCK prefix and instruction encoding associated therewith are used to indicate a non-transactional access, although any other suitable prefix and instruction encoding may be used. In at least one embodiment, core 102 implements inverted default semantics consistent with the instructions of Table 3.

TABLE 3
Instruction Set Extensions for Inverted Default Semantics

| Category | Instruction | Function |
|---|---|---|
| Transaction | SPECULATE | Start a transaction |
| Boundary | | |
| Transaction | COMMIT | End a transaction |
| Boundary | | |
| Transactional | LOCK MOV [Reg], | Non-transactional load from |
| Memory Access | [Addr] | [Addr] to [Reg] |
| Transactional | LOCK MOV [Addr], | Non-transactional store from |
| Memory Access | [Reg] | [Reg] to [Addr] |
| Context Control | ABORT | Abort a current transaction |

Still referring to FIG. 4, decoder 204 and/or other suitable portions of core 102 decodes an instruction (402). If the instruction is not in a speculative region of code (404), the instruction is decoded as a load/store instruction (410), and the instruction includes a lock prefix, then the instruction is illegal and may trigger an exception on core 102. If the instruction is not in a speculative region of code (404) and the instruction is not a load/store instruction (410), then the instruction is decoded as a non-transactional instruction (418). If the instruction is not in a speculative region of code (404) and the instruction is a load/store instruction (410) but does not include a prefix (412), then the instruction is decoded as a non-transactional instruction (418).

If decoder 204 indicates that an instruction is within a speculative region of code (404) and the instruction is not a load/store instruction or other instruction that accesses memory (e.g., logical or arithmetic instructions ADD, INC, or AND, or other instruction that can directly operate on memory operands) (406), then the instruction is decoded to execute as a transactional memory access (416). If the instruction is within a speculative region of code (404), the instruction is a load/store instruction or other instruction that touches memory (e.g., logical or arithmetic instructions ADD, INC, or AND, or other instruction that directly operates on memory operands) (406), but does not include a prefix, then the instruction is decoded to execute as a transactional memory access (416). However, if the instruction is within a speculative region of code (404), the instruction is a load/store instruction or other instruction that touches memory (406) and includes a prefix, then the instruction is decoded to execute as a non-transactional access (418). This type of inverted default semantics facilitates executing standard code (e.g., generated by an unmodified compiler) transactionally, although the code may have been originally written for non-transactional execution.

Referring back to FIG. 2, in at least one embodiment of core 102, when decoder 204 detects a transactional memory access, decoder 204 generates an indicator of a transactional memory access, which may be stored in a control register (e.g., in register file 214). When core portion 204 is configured to implement in-speculative-region inverted default semantics of FIG. 4 and the memory access instruction is within a speculative region of an instruction sequence, decoder 204 configures the control signal to indicate a transactional memory access in response to a memory access instruction without an indicator of transactional memory access. Decoder 204 is configured to generate the indicator of a transactional memory access as a default when decoding instructions within the speculative region of code. In addition, when in the speculative region of the instruction sequence, the instruction decoder is configured to generate an indication of the memory access being non-transactional in response to a memory access having an indicator of a transactional memory access (e.g., LOCK prefix) or other suitable indicator. Decoder 204 indicates a non-transactional memory access in response to memory accesses outside a speculative region of code. Accordingly, decoder 204 facilitates reuse of code (e.g., libraries) written using higher-level languages that do not indicate transactional memory regions and code written for non-transactional memory systems.

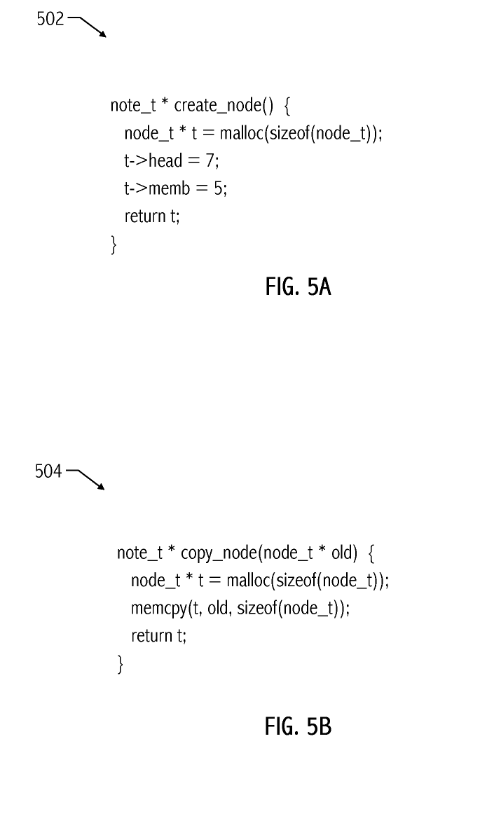

Referring to FIGS. 5A and 5B, exemplary program portion 502 creates a node by allocating a node using malloc( ), initializing the node, and returning a pointer to the node. Exemplary program portion 504 copies a node by allocating a new node using malloc( ), copying the contents of the node to the new node, and returning a pointer to the new node. Note that to simplify this example, system calls for malloc are ignored. When program portion 502 or program portion 504 is executed on a core that does not implement in-speculative-region inverted default semantics, without modification, program portions 502 and 504 execute as non-transactional operations, whether or not program portions 502 and 504 are included in a speculative region of code. When program portions 502 and 504 are executed in a speculative region of code on a core that implements in-speculative-region inverted default semantics, program portion 502 and 504 execute transactionally, without modification. When program portions 502 and 504 are executed in a nonspeculative region of code on a core that implements inverted default semantics, without modification, program portion 502 and 504 execute nontransactionally.

While circuits and physical structures are generally presumed, it is well recognized that in modern semiconductor design and fabrication, physical structures and circuits may be embodied in computer-readable descriptive form suitable for use in subsequent design, test or fabrication stages. Structures and functionality presented as discrete components in the exemplary configurations may be implemented as a combined structure or component. The invention is contemplated to include circuits, systems of circuits, related methods, and computer-readable medium encodings of such circuits, systems, and methods, all as described herein, and as defined in the appended claims. As used herein, a computer-readable medium includes at least disk, tape, or other magnetic, optical, semiconductor (e.g., flash memory cards, ROM) medium.

The description of the invention set forth herein is illustrative, and is not intended to limit the scope of the invention as set forth in the following claims. For example, while the invention has been described in an embodiment that uses an x86 architecture and particular instruction set extensions, one of skill in the art will appreciate that the teachings herein can be utilized with other computer architectures and instructions. In addition, note that while the invention has been described in an embodiment that uses boundary instructions and instruction prefixes to indicate transactional memory accesses, one of skill in the art will appreciate that the teachings herein can be utilized with other techniques for indicating transactional memory accesses, e.g., dedicated transactional memory access instructions and dedicated non-transactional memory access instructions. Variations and modifications of the embodiments disclosed herein, may be made based on the description set forth herein, without departing from the scope and spirit of the invention as set forth in the following claims.

What is claimed is:

1. A method for accessing memory by a first processor of a plurality of processors in a multi-processor system comprising:
responsive to a memory access instruction within a speculative region of a program, accessing contents of a memory location using a transactional memory access according to the memory access instruction unless the memory access instruction indicates a non-transactional memory access.

2. The method, as recited in claim 1, wherein the memory access instruction indicates a non-transactional memory access and the accessing contents of the memory location includes using a non-transactional memory access by the first processor according to the memory access instruction within the speculative region of the program.

3. The method, as recited in claim 1, further comprising:
responsive to the memory access instruction not being in the speculative region of the program, accessing contents of the memory location using a non-transactional memory access by the first processor according to the memory access instruction.

4. The method, as recited in claim 1, wherein responsive to the memory access instruction not being annotated to be a non-transactional memory access, the method further comprising:
responsive to the speculative region of the program executing successfully, updating contents of the memory location.

5. The method, as recited in claim 1, wherein the memory access is not annotated to be a non-transactional memory access, further comprising:
making an update to the memory location visible to other processors of the plurality of processors concurrently with at least one other update to another memory location accessed within the speculative region of the program corresponding to another memory access not annotated to be a non-transactional memory access.

6. The method, as recited in claim 1, further comprising:
responsive to unsuccessful execution of the speculative region of the program, aborting modifications to contents of the memory location.

7. The method, as recited in claim 1, wherein the speculative region is indicated by at least one transactional boundary instruction of the program.

8. The method, as recited in claim 1, wherein the memory access instruction is annotated by a prefix to indicate a non-transactional memory access.

9. The method, as recited in claim 1, wherein the memory access instruction is included in a function written for a non-transactional memory system.

10. The method, as recited in claim 1, wherein the memory access instruction is a logical or arithmetic instruction having memory operands.

11. An apparatus comprising:
a plurality of processor cores responsive to access a memory; and
at least a first processor core of the plurality of processor cores responsive to execute a non-transactional memory access instruction as a transactional memory access when the non-transactional memory access instruction is located within a speculative region of code.

12. The apparatus, as recited in claim 11, wherein the speculative region of code is indicated by at least one transaction boundary instruction.

13. The apparatus, as recited in claim 11, wherein the first processor core comprises an instruction decoder responsive to generate an indicator of a transactional memory access in response to a memory access instruction without an indicator of transactional memory access, responsive to the memory access instruction being within a speculative region of an instruction sequence.

14. The apparatus, as recited in claim 11, wherein the instruction decoder is responsive to generate the indicator of a transactional memory access as a default when decoding instructions within the speculative region of code.

15. The apparatus, as recited in claim 11, wherein, when in the speculative region of the instruction sequence, the instruction decoder is configured to generate an indication of the memory access being non-transactional in response to a memory access instruction including a LOCK prefix.

16. The apparatus, as recited in claim 11, further comprising:
the memory, wherein the memory is configured to perform the memory access instruction as a transactional memory access in response to the indicator of a transactional memory access.

17. The apparatus, as recited in claim 11, wherein, when in a non-speculative region of the instruction sequence, the instruction decoder is configured to perform a non-transactional memory access in response to a memory access instruction without an indicator of transactional memory access.

18. The apparatus, as recited in claim 11, wherein the non-transactional memory access instruction is a logical or arithmetic instruction having memory operands.

19. An apparatus comprising:
an instruction decoder responsive to generate an indicator of a transactional memory access in response to a memory access instruction without an indicator of transactional memory access, when the memory access instruction is located in a speculative region of an instruction sequence.

20. The apparatus, as recited in claim 19, wherein the instruction decoder generates the indicator of a transactional memory access as a default when within a speculative region of an instruction sequence.

21. The apparatus, as recited in claim 19, wherein the memory access instruction is a logical or arithmetic instruction having memory operands.
